(19) United States
(12) Patent Application Publication
(10) Pub. No.: US 2013/0266275 A1
(43) Pub. Date: Oct. 10, 2013

(54) COAXIAL CONNECTOR WITH INGRESS REDUCTION SHIELD

(71) Applicant: Michael Holland, Santa Barbara, CA (US)

(72) Inventor: Michael Holland, Santa Barbara, CA (US)

(21) Appl. No.: 13/712,828

(22) Filed: Dec. 12, 2012

Related U.S. Application Data
(60) Provisional application No. 61/620,355, filed on Apr. 4, 2012.

(51) Int. Cl. G02B 6/38

(52) U.S. Cl. CPC G02B 6/3869
USPC 385/90

(57) ABSTRACT

A coaxial connector with an F female end shield is configured to restrict RF ingress.

### PRIORITY CLAIM

The present invention claims the benefit of U.S. Provisional Patent Application 61/620,355 filed Apr. 4, 2012 and entitled COAXIAL CONNECTOR WITH INGRESS REDUCTION SHIELD.

### BACKGROUND OF THE INVENTION

1. Field of the Invention

The present invention relates to an article of manufacture for conducting electrical signals. In particular, F-Type connectors are equipped to reject RF ingress.

2. Discussion of the Related Art

FIGS. 1, 2, 3A-C, and 4 show prior art F-Type connectors. FIG. 1 shows a perspective view 100 of a prior art F female port 102 mounted to a wall disk 104. FIG. 2 shows a side view 200 of FIG. 1 revealing a coaxial cable 208 attached via a F male connector 206 to the F female port and leaving a room facing attachment end 204 of the F female port exposed to stray signals or RF ingress 210.

FIGS. 3A-C show a cross-sectional view 300A, side view 300B and a perspective view 300C of a prior art F splice with female ports 332, 334 at opposed ends. This splice provides interconnected internal contacts 312, 314 for engaging respective coaxial cable center conductors and a metal body for engaging F male connector couplings such as threaded nuts and having electrical continuity with respective coaxial cable outer conductors. A splice electrically conductive body 316 such as a metallic body provides for transport of a coaxial cable ground signal.

Threads 322, 324 at opposing ends of the splice tubular body 316 provide a means for engaging F male connector couplings at the splice end ports. The splice assembly end ports 332, 334 typically include an inwardly directed shallow metal lip 342 that may be rolled from the body or provided in another fashion, for example by fixing a shallow ring at the tube end. The lip provides peripheral support to a disk shaped end insulator 344 within the splice body. An insulator central aperture 346 is for receiving a center conductor of a coaxial cable. Behind this insulator is the internal contact 312 (314) mentioned above.

FIG. 4 shows a cross-sectional view of a bulkhead port 400. The port has a F female port 432 at one end and a mount 450 at an opposed end. Similar to the splice above, the port includes an electrically conductive body 416, an internal contact 412 behind an insulator 444 held in place by a port end lip 442. An aperture 441 in the insulator provides for inserting a coaxial cable center conductor into the port contact 412 and body threads 422 provide for engaging an F male connector coupling such as a threaded nut.

Unlike the splice 300A-C, the bulkhead port 400 has a mount 450 at one end that may be separate from or include portions of a device/equipment bulkhead or portion(s) thereof. The mount supports the bulkhead port from a base 452. A trailing portion of the contact 412 passes through a hole in a base insulator 456 and then through a hole 458 in the base. As may be required, the base is insulated from the contact by an air gap or by another means known to skilled artisans.

These prior art connectors may become the source of future problems as proliferation of RF devices such as cellular telephones increases the chances RF ingress will adversely affect interconnected systems such as cable television and satellite television signal distribution systems.

Persons of ordinary skill in the art have recognized that in cable television and satellite television systems (“CATV”), reduction of interfering radio frequency (“RF”) signals improves signal to noise ratio and helps to avoid saturated reverse amplifiers and related optic transmission that is a source of distortion.

And, past efforts have limited some sources of the ingress of interfering RF signals into CATV systems. These efforts have included increased use of traditional connector shielding, multi-braid coaxial cables, connection tightening guidelines, increased use of traditional splitter case shielding, and high pass filters to limit low frequency spectrum interfering signal ingress in active home CATV systems.

The F connector is the standard connection used for cable television and satellite signals in the home. For example, in the home one will typically find a wall mounted female F connector or a coaxial cable “drop” splitter or isolator for supplying a signal to the TV set, cable set-top box, or internet modem.

A significant location of unwanted RF signal and noise ingress into CATV systems is in the home. This occurs where the subscriber leaves a CATV connection such as a wall-mounted connector or coaxial cable drop connector disconnected/open. An open connector end exposes a normally metallically enclosed and shielded signal conductor and can be a major source of unwanted RF ingress.

As shown above, a CATV signal is typically supplied to a room via a wall mounted connector or in cases a simple “cable drop.” These and similar cable interconnection points provide potential sources of unwanted RF signal ingress into the CATV system. As will be appreciated, multiple CATV connections in a home increase the likelihood that some connections will be left unused and open, making them a source of unwanted RF ingress. And, when subscribers move out of a home, CATV connections are typically left open, another situation that invites RF ingress in a CATV distribution system.

Known methods of eliminating unwanted RF ingress in a CATV system include placing a metal cap over each unused F connector in the home or, placing a single metallic cap over the feeder F port at the home network box. But, the usual case is that all home CATV connections are left active and when unused, open, a practice the cable television operators and the industry have accepted in lieu of making costly service calls associated with new tenants and/or providing the CATV signal in additional rooms.

The inventor's work in this area suggests current solutions for reducing unwanted RF ingress resulting from open connectors are not successful and/or not widely used. Therefore, to the extent the CATV industry comes to recognize a need to further limit interfering RF ingress into CATV systems, it is desirable to have connectors that reduce RF ingress when they are left open.

Prior art exists which attempts to accomplish this goal but is generally thought to be prohibitively expensive, impractical, or mechanically unreliable. For example, one prior art method disclosed in patent applications of the present inventor disconnects the center conductor contact when the F female is not connected to a male connector. Another method is disclosed in U.S. Pat. No. 8,098,113 where an electronic method differentially cancels noise common to both the center conductor and shield and requires an electric power source. These methods are relatively expensive compared with at least some embodiments of the present invention. They also have reliability limitations due to either of included mechanical or electrical elements.

Presently, it appears the industry accepts the status quo as satisfactory and there is little evidence of further RF ingress reduction efforts. However, in the inventor's view, there remain good reasons to develop improvements further limiting the ingress of interfering RF signals into CATV systems.

### SUMMARY OF THE INVENTION

The present invention provides a shield against unwanted radio frequency (“RF”) transfer in coaxial cable installations. Shielding devices of the present invention include electromagnetic radiation shields such as waveguides adapted to function in conjunction with coaxial cable connectors.

Electromagnetic shields include devices causing electric charges within a metallic shield to redistribute and thereby cancel the field's effects in a protected device interior. For example, an interior space can be shielded from certain external electromagnetic radiation when effective materials(s) and shield geometry(ies) are used.

Applications include cavity openings that are to be shielded from ingress, or in cases, egress, of certain RF signals or noise with an appropriate shield located at the opening. Effective shields include perforated structures such as screens, fabrics, perforated plates, and perforated disks. In effect, these shields are waveguide(s) tending to attenuate and/or reject passage of certain frequencies.

In the context of a coaxial cable connector, connector internal conductors or portions thereof may act as antennas to receive unwanted RF signals and noise via connector openings.

Coaxial cable connectors can be shielded from unwanted RF ingress even when a coaxial cable connector end is left open, for example when an F female port or connector end is left open. In various embodiments, unwanted RF ingress is restricted in a coaxial connector by, inter alia, appropriately selecting waveguide geometry including in some embodiments the size of a waveguide central aperture.

In various embodiments, coaxial cable connector waveguides are electrical conductors such as plates and fabrics. Plates include disks and in particular generally circular disks. Fabrics include meshes and weaves. Exemplary RF screens are made from a conducting material and have opening size(s) and thickness(es) that are effective to preferentially block RF ingress such as RF ingress in a particular frequency band. Suitable waveguide materials generally include conductors and non-conductors coated and/or impregnated with conductors.

Incorporated by reference herein in its entirety and for all purposes are the exemplary shield technologies described in U.S. Pat. No. 7,371,977 to inventor Preonas, including in particular the shields of FIGS. 2 and 3 and shield design considerations of FIG. 4. As skilled artisans will recognize, analytical shield and waveguide design methods are generally available and include code incorporating Faraday's Law and finite element modeling techniques. Use of these well-known tools by skilled artisans will typically provide good approximations of shield design variables including waveguide aperture size, thickness, and choice of material.

Inventor experiments on some prototype waveguide designs generally showed a) increasing waveguide thickness tended to increase connector impedance while and b) increasing aperture size tended to reduce shielding.

FIG. 5 shows a chart of waveguide thickness versus waveguide aperture size 500. In particular, the chart shows ranges of aperture size and thickness within a particular region, Region 1, that tend to yield desirable RF ingress attenuation in CATV applications. Region 1 is bounded by aperture sizes of approximately 2 to 3 mm and waveguide thicknesses of approximately 0.5 to 2 mm. Several waveguides with dimensions in Region 1 were found to be useful for blocking unwanted RF ingress typical of CATV applications.

Embodiments of the present invention provide solutions to problematic RF ingress into CATV distribution systems via open ended coaxial cable connectors subject to unwanted RF transfer. For example, in various embodiments an F female connector is shielded to restrict RF transfer at frequencies below 100 MHz while allowing the connector to mate with a male coaxial connector with insignificant degradation of a desired impedance, such as a nominal 75 ohm impedance. Embodiments of the invention also mitigate RF transfer into home satellite television systems utilizing dish to receiver frequencies in the range of 950-2150 MHz.

As will be appreciated, the disclosure of the present invention has application to additional frequency bands and signal types. In various embodiments, providing effective material, hole size, and thickness enables wide adaptations of the present invention.

An embodiment of the invention provides a smaller entry hole of 2 to 3.5 mm with a nominal thickness of between 0.5 to 1.5 mm. This combination of hole size and thickness acts as a waveguide to restrict ingress of low frequencies, typically under 100 Mhz by 20-40 dB (in some cases 1/100 of the signal) of that of an open-ended F port (See FIG. 9). The combination of sizes serves to restrict the low frequency ingress while only minimally reducing the impedance of the operational connector interface. The reduced impedance match (sometimes characterized in terms of return loss) of the invention is still above the minimally acceptable level of the CATV industry. If the hole is above 3.5 mm, some RF is restricted but there is typically less shielding of the connector entry. A purpose of some embodiments of the invention is to maximize the RF shielding or ingress at low frequency while providing a good impedance match of the connector interface during operation. The thickness of the end surface or shield disk is also a main factor in some embodiments. A thickness range of between 0.5 to 1.5 mm was found to be effective in blocking frequencies under 100 Mhz in some embodiments.

An embodiment of the invention uses a 2 mm end hole or shield. And, some embodiments use tuned slots in addition to the 2 to 3.5 mm aperture. These slots or waveguide bars may be added to the port end surface or to an internal shield disk for specific frequency restriction.

An embodiment of the invention uses a shield disk from a polymer or ceramic material that can be coated or impregnated with a magnetic material active at specific frequencies. In addition to being homogeneously mixed with the ceramic or polymer, the material can be deposited or sputters on the shield disk surface in different thicknesses or patterns to better affect specific frequencies. The shield may be a combination of waveguide and sputters or deposited material to more economically produce the shield.

In various embodiments, the invention comprises: an outer connector body; a female end of the connector is for engaging a male coaxial cable connector; the connector female end having a waveguide with an aperture for receiving a center conductor of a coaxial cable; wherein the diameter of the aperture is in the range 1.3 mm to 3.0 mm; and, wherein the waveguide is configured to shield connector body internals from ingress of radio frequency signals in the range of 10 to 100 megahertz. And, in some embodiments, the connector further comprises: a waveguide surface; the waveguide surface bordering the aperture and an aperture centerline about perpendicular to the waveguide surface; the thickness of a waveguide surface measured along a line parallel to the aperture centerline is not less than 0.5 mm; and, the thickness of the waveguide surface measured along a line parallel to the aperture centerline is not more than 1.5 mm. And, in some embodiments, the connector further comprises: wherein the diameter of the aperture and the thickness of the waveguide are selected in a manner consistent with achieving a connector impedance of 75 ohms. And, in some embodiments, the connector further comprises: a rim of the outer connector body; and, the waveguide formed by the rim. And, in some embodiments the connector alternatively comprises: a rim of the outer connector body; and, the waveguide formed by a disk held in place by the rim.

And, in various embodiments, the invention comprises: an outer connector body; a female end of the connector is for engaging a male coaxial cable connector; the connector female end having a waveguide with an aperture for receiving a center conductor of a coaxial cable; the diameter of the aperture is not less than two times the diameter of the center conductor; the diameter of the aperture is not more than 4 times the diameter of the center conductor; and, wherein the waveguide is configured to shield connector body internals from ingress of radio frequency signals in the range of 10 to 100 megahertz while maintaining a nominal connector impedance of 75 ohms. And, in some embodiments, the connector further comprises: a waveguide surface; the waveguide surface bordering the aperture and an aperture centerline about perpendicular to the waveguide surface; the thickness of a waveguide surface measured along a line parallel to the aperture centerline is not less than 0.5 mm; and, the thickness of the waveguide surface measured along a line parallel to the aperture centerline is not more than 1.5 mm. And, in some embodiments, the connector further comprises: wherein the diameter of the aperture and the thickness of the waveguide are selected in a manner consistent with achieving a connector impedance of 75 ohms. And, in some embodiments, the connector further comprises: a rim of the outer connector body; and, the waveguide formed by the rim. And, in some embodiments, the connector alternatively comprises: a rim of the outer connector body; and, the waveguide formed by a disk held in place by the rim.

Yet other embodiments of the invention comprise a female F connector with an end opening body hole or separate entry disk behind the hole opening from 1.5 to 3 mm port with a thickness of 0.5 to 1.5 mm. In some embodiments, the disk is made from a metallic material and in some embodiments the disk is made from a metallically impregnated polymer or ceramic material. Some embodiments of the disk are made with additional waveguide slots and some embodiments of the disk are made including one or more of a polymer, ceramic, or fiberglass material for example with a sputtered or etched magnetic material on the surface.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows a perspective view of a prior art F port and splice.

FIG. 2 shows a side view of FIG. 1.

FIG. 3A-C show prior art F splice views.

FIG. 4 shows a prior art bulkhead type F port.

FIG. 5 shows a chart of waveguide dimensions for some embodiments of the present invention.

FIG. 6 shows in partial section a first embodiment of the connector with shield of the present invention.

FIG. 7 shows in partial section a second embodiment of the connector shield of the present invention.

FIG. 8 shows the connector of FIG. 6 with a variety of waveguide disks.

FIG. 9 shows a performance chart of one embodiment of the connector of the present invention.

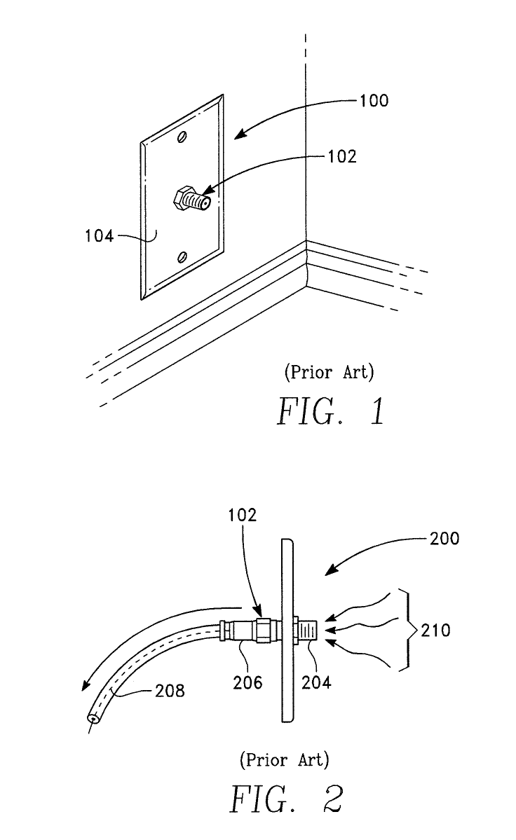

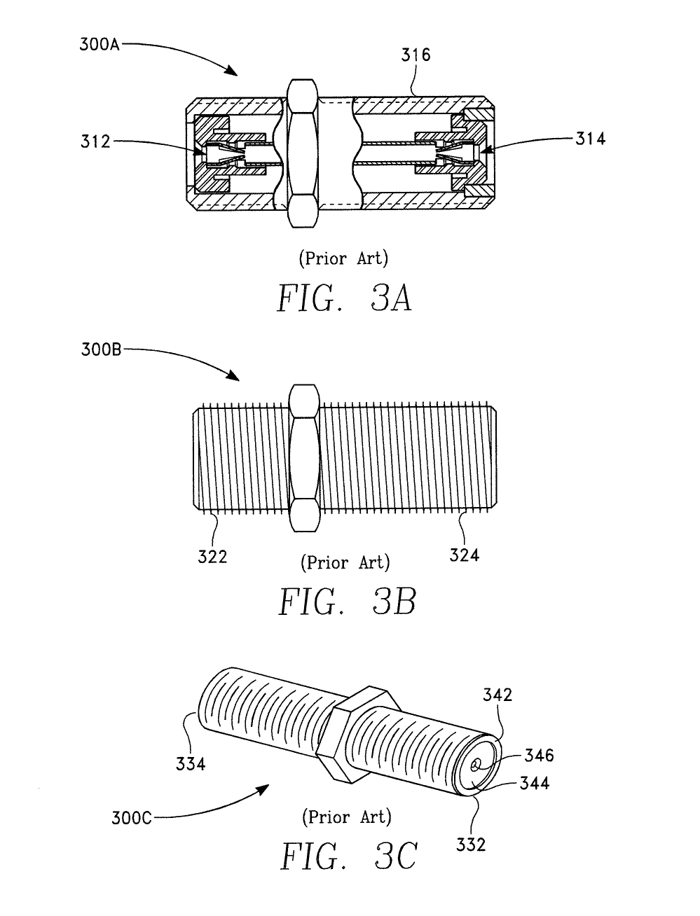

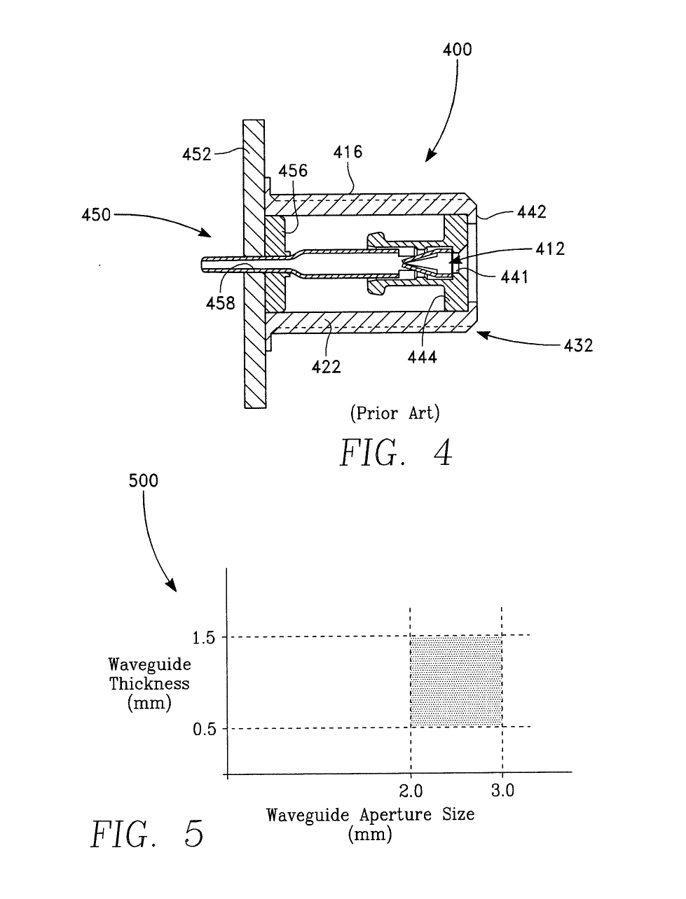

### DESCRIPTION OF THE PREFERRED EMBODIMENTS

The disclosure provided herein describes examples of some embodiments of the invention. The designs, figures, and descriptions are non-limiting examples of the embodiments they disclose. For example, other embodiments of the disclosed device and/or method may or may not include the features described herein. Moreover, disclosed advantages and benefits may apply to only certain embodiments of the invention and should not be used to limit the disclosed invention.

Embodiments of the invention provide a method of reducing RF cable interconnection ingress. In various embodiments, cable interconnection RF ingress is reduced by including a filter such as a waveguide and/or a screen at the cable entry end of an F-Type female port. Examples include filters that are frequency and/or frequency range specific.

Restriction of the ingress of RF frequencies may be for particular applications such as restricting frequencies below 100 MHz for CATV applications and specific frequencies for satellite and home networking. Because ingress restriction devices may change an F connector's characteristic impedance, for example 75 Ohm devices, filter geometry may be varied to balance filter performance and maintenance of a desired characteristic impedance within an acceptable range.

Notably, typical F female port geometry includes entry hole sizes that range from 4.0-5.5 mm as compared with the F connector tube or body overall diameter of 9.7 mm (⅜-32 outer thread). CATV industry standards promulgated by the Society of Cable Television Engineers (“SCTE”) show a minimum port opening of 4.3 mm to insure desired connector impedance when, for example, they cannot control the corresponding annular end wall thickness. By selecting filter performance related dimensions and materials, embodiments of the present invention reduce stray signal ingress while maintaining particular return loss performance such as an SCTE recommended minimum return loss of 20 dB.

Applicant notes that in telecommunications, return loss is the loss of signal power resulting from the reflection caused by a discontinuity in a transmission line. This discontinuity can be a mismatch with the terminating load or with a device inserted in the line. It is usually expressed in decibels (dB)

$$RL ( dB ) = 10 {log}_{10} \frac{{P}_{i}}{{P}_{r}}$$

where RL(dB) is the return loss in dB, Pᵢ is the incident power and Pᵣ is the reflected power. Return loss is related to both standing wave ratio (SWR) and reflection coefficient (σ). Increasing return loss corresponds to lower SWR. Return loss is a measure of how well devices or lines are matched. A match is good if the return loss is high. A high return loss is desirable and results in a lower insertion loss.

In some embodiments, the invention provides a waveguide in the form of a waveguide “washer,” that is an electrically conductive disk with a central hole. In an embodiment, a waveguide aperture or entry hole diameter is in the range of 2.0-2.5 mm and the waveguide thickness in the range of 0.5-1.5 mm. This particular combination of waveguide hole size and thickness provides a device for restricting ingress of frequencies typically below 100 MHz with significant attenuation. Embodiments provide RF ingress attenuation in the range of 20-40 dB (reductions to 1/100 of the signal) when compared with RF ingress of an open-ended F female port without the waveguide or other RF ingress protection. Persons of ordinary skill in the art will recognize waveguide dimensions may be varied within and around the ranges to provide particular waveguide and connector performance.

Dimensions of waveguide aperture and thickness may be chosen to restrict RF ingress such as low frequency ingress managing the impedance of the operational connector interface. Embodiments of the invention perform with return losses acceptable in the CATV and satellite television industry. For example, where the waveguide aperture size is greater than 3 mm, RF ingress continues to be restricted to some degree but there is less shielding of the connector entry. Embodiments of the invention may enhance RF shielding for ingress at low frequencies while providing a good impedance match of the connector interface while in operation. For example, various embodiments control the thickness of the end surface or shield disk to enhance performance. Waveguide thicknesses in the range of 0.5 to 1.5 mm have demonstrated an ability to block frequencies below 100 MHz.

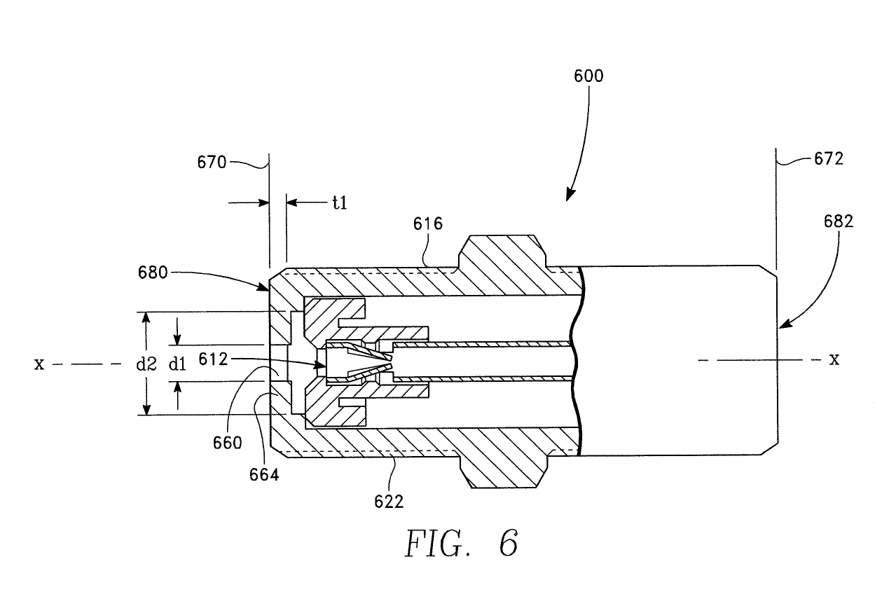

FIG. 6 shows an F-Type splice embodiment of the present invention with an integral waveguide 600. A tubular, electrically conductive splice body 616 extends between first and second ends 670, 672 of the body locating two F female ports 680, 682. An outer diameter of the body is threaded 622 for engaging male connector(s).

A shielded port 680 with an internal contact 612 is located near the first end 670. The port is shielded by an integral waveguide in the form of an inwardly directed integral lip. Forming a centrally located and relatively small shielded port aperture 660 with diameter d1, the lip is deep as compared with prior art port lips. A lip diameter d2 (d2>d1) describes an annulus 664 between d1 and d2 having a thickness t1 measured along a central axis x-x of the connector. Typically, only one end of the splice will have need of a shielded port given the opposite end usually remains attached to a mating male connector during the splice service life. As such, only the end opposite this undisturbed connection may be shielded.

In various embodiments the waveguide aperture has a diameter d1 that is smaller than the wavelength of stray RF signals to be attenuated before reaching the connector contact or other similar connector parts behind the waveguide. In various embodiments the waveguide has a thickness t1 in the range of 0.5 to 1.5 mm and an aperture diameter in the range of 2.0 to 3.0 mm. And, in various embodiments the waveguide aperture has a thickness t1 that is less than the aperture diameter (t1<d1). In an embodiment suited for use in some CATV applications, the inventor determined approximate dimensions t1=1.3 mm, d1=2.0 mm, and d2=5.5 mm provided significant attenuation of RF ingress frequencies below 100 MHz.

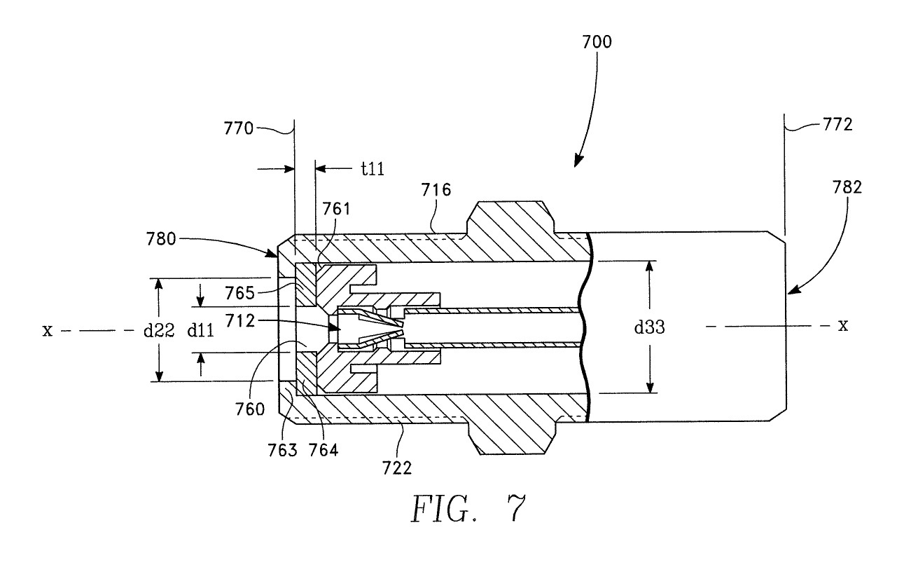

FIG. 7 shows an F-Type splice embodiment of the present invention with an disk waveguide 700. An electrically conductive splice body 716 extends between first and second ends 770, 772 of the body locating two F female ports 780, 782. An outer diameter of the body is threaded 722 for engaging male connector(s).

A shielded port 780 with an internal contact 712 is located near the first end 770. The port is shielded by a disk waveguide in the form of a perforated disk 764. As used here, disk includes any of thin or thick plates, relative to other plate dimensions, having a circular or another cross-sectional shape. As shown, the disk has an outer diameter d33 and a disk periphery 761 that is supported by an inwardly directed rim 763 of the connector body 716. As skilled artisans will appreciate, other methods of locating and/or supporting the disk may also be used.

The disk includes a relatively small and centrally located shielded port aperture 760 with diameter d11. The disk defines an inwardly directed disk lip 765 that is deep as compared with prior art port lips and in some embodiments is coextensive with the disk 764. The disk has a thickness t11 measured along a central axis x-x of the connector. Typically, only one end of the splice will have need of a shielded port given the opposite end usually remains attached to a mating male connector during the splice service life. As such, only the end opposite this undisturbed connection may to be shielded.

In various embodiments the waveguide aperture has a diameter d11 that is smaller than the wavelength of stray RF signals to be attenuated before reaching the connector contact or other similar connector parts behind the waveguide. In various embodiments the waveguide has a thickness t11 in the range of 0.5 to 1.5 mm and an aperture diameter in the range of 2.0 to 3.0 mm. And, in various embodiments the waveguide aperture has a thickness t11 that is less than the aperture diameter (t11<d11). In an embodiment suited for use in some CATV applications, the inventor determined approximate dimensions t11=1.3 mm, d11=2.0 mm, and d22=5.5 mm provided significant attenuation of RF ingress frequencies below 100 MHz.

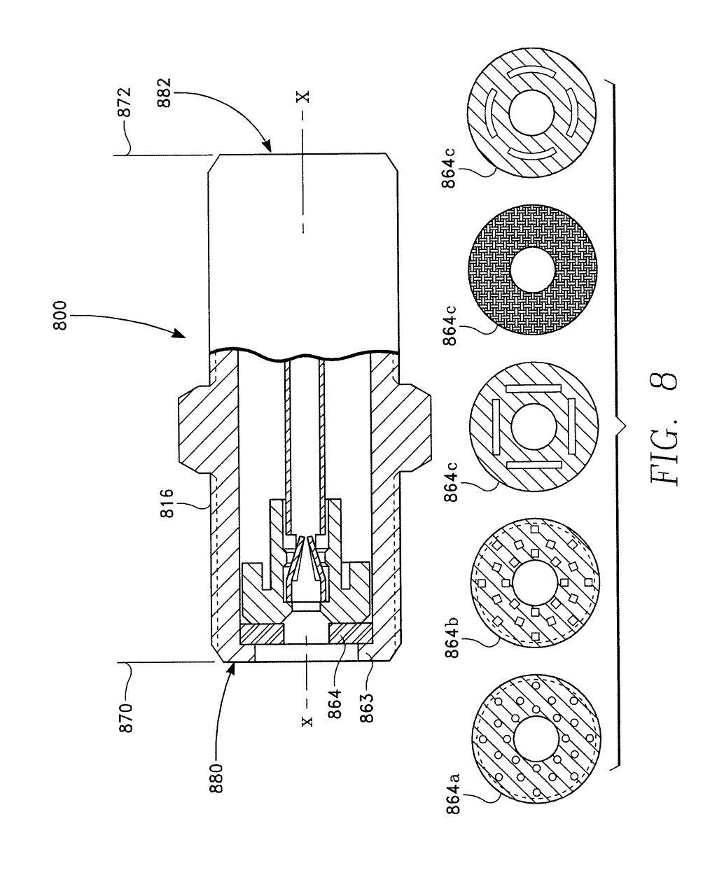

FIG. 8 shows an F-Type splice embodiment of the present invention with a disk waveguide 800. A tubular, electrically conductive splice body 816 extends between first and second ends 870, 872 of the body locating two F female ports 880, 882.

As shown, an electrically conductive disk waveguide 864 is internal to the connector body 816 and is near a locating and/or supporting part such as an inwardly directed rim 863 of the connector body. As skilled artisans will appreciate, other methods of locating and/or supporting the disk may also be used. For example, a removable screw-in plug, circlip, or similarly useful device may retain the disk.

In addition to varying the size of a hole in a perforated disk such as a disk with a center hole, disk type waveguides may utilize a plurality of holes to obtain a desired performance. These holes may be of the same or different sizes and may include or exclude a center hole. Hole shapes may also be varied.

Five exemplary multi-hole disks 864a-e are shown in FIG. 8. A first disk 864a has circular center hole and additional smaller holes arranged along radii of the disk. A second disk 864b has a circular center hole and additional smaller rectangular or square holes arranged along radii of the disk. A third disk 864c has a circular center hole and comparatively narrow rectangular slots with a longitudinal axis about perpendicular to disk radii. A fourth disk 864d has a circular center hole and is made of a mesh with openings smaller than the centerole. The fifth disk 864e has a circular centerole and plural relatively small rectangular slots having longitudinal axes arranged about perpendicular to disk radii.

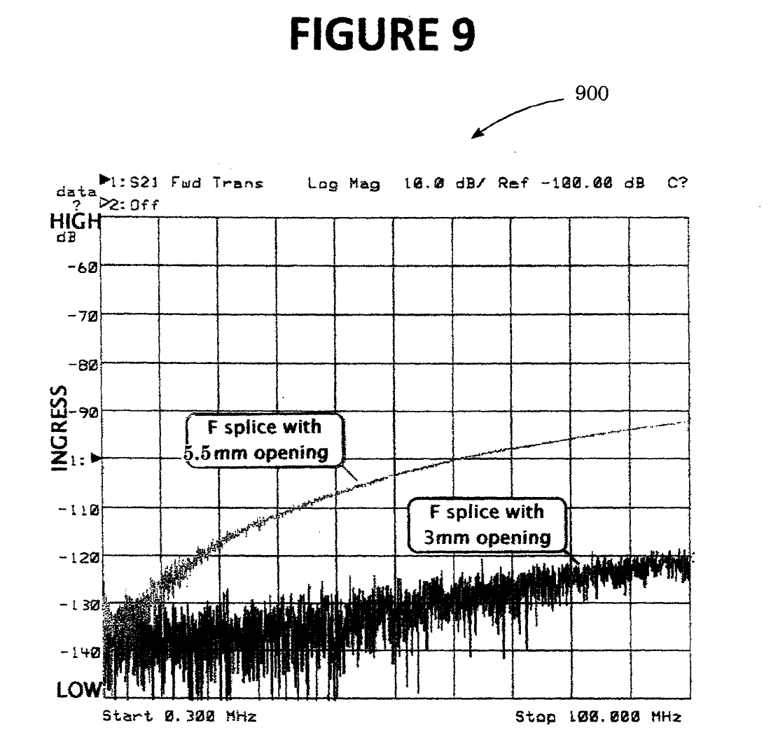

FIG. 9 shows a performance graph for a coaxial cable connector with two different F splices 900. This chart is a digital recording of a test instrument display made during testing of a prototype connector with a port shielded in accordance with the present invention. The upper curve marked “F splice with 5.5 mm [aperture] opening” lacks the shield of the present invention and shows RF ingress that varies between about −140 dB and −90 dB over the ingress frequency range 0.3 to 100 MHz. The lower curve marked “F splice with 3 mm [aperture] opening” includes an embodiment of the shield of the present invention and shows ingress that is much reduced, varying between about −140 dB and −120 db over the same 0.3 to 100 Mhz range of RF ingress frequencies. As can be seen from the chart, improvements in the range of about 20-40 dB can occur over the range of frequencies tested.

The present invention has been disclosed in the form of exemplary embodiments. However, it should not be limited to these embodiments. Rather, the present invention should be limited only by the claims which follow where the terms of the claims are given the meaning a person of ordinary skill in the art would find them to have.

What is claimed is:

1. A coaxial cable connector comprising:
an outer connector body;
a female end of the connector is for engaging a male coaxial cable connector;
the connector female end having a waveguide with an aperture for receiving a center conductor of a coaxial cable;
wherein the diameter of the aperture is in the range 1.3 mm to 3.0 mm; and,
wherein the waveguide is configured to shield connector body internals from ingress of radio frequency signals in the range of 10 to 100 megahertz.

2. The connector of claim 1 further comprising:
a waveguide surface;
the waveguide surface bordering the aperture and an aperture centerline about perpendicular to the waveguide surface;
the thickness of a waveguide surface measured along a line parallel to the aperture centerline is not less than 0.5 mm; and,
the thickness of the waveguide surface measured along a line parallel to the aperture centerline is not more than 1.5 mm.

3. The connector of claim 2 wherein the diameter of the aperture and the thickness of the waveguide are selected in a manner consistent with use in a 75 ohm connection.

4. The connector of claim 3 further comprising:
a rim of the outer connector body; and,
the waveguide formed by the rim.

5. The connector of claim 3 further comprising:
a rim of the outer connector body; and,
the waveguide formed by a disk separable from the connector body.

6. A coaxial cable connector comprising:
an outer connector body;
a female end of the connector is for engaging a male coaxial cable connector;
the connector female end having a waveguide with an aperture for receiving a center conductor of a coaxial cable;
the diameter of the aperture is not less than two times the diameter of the center conductor;
the diameter of the aperture is not more than 4 times the diameter of the center conductor; and,
wherein the waveguide is configured to shield connector body internals from ingress of radio frequency signals in the range of 10 to 100 megahertz while maintaining a nominal connector impedance of 75 ohms.

7. The connector of claim 6 further comprising:
a waveguide surface;
the waveguide surface bordering the aperture and an aperture centerline about perpendicular to the waveguide surface;
the thickness of a waveguide surface measured along a line parallel to the aperture centerline is not less than 0.5 mm; and,
the thickness of the waveguide surface measured along a line parallel to the aperture centerline is not more than 1.5 mm.

8. The connector of claim 6 wherein the diameter of the aperture and the thickness of the waveguide are selected in a manner consistent with achieving a connector impedance of 75 ohms.

9. The connector of claim 8 further comprising:
a rim of the outer connector body; and,
the waveguide formed by the rim.

10. The connector of claim 8 further comprising:
a rim of the outer connector body; and,
the waveguide formed by a disk held in place by the rim.

11. A female F connector with an end opening body hole or separate entry disk behind the hole opening from 1.5 to 3 mm port with a thickness of 0.5 to 1.5 mm.

12. The disk in claim 11 made from a metallic material.

13. The disk on claim 11 made from a metallically impregnated polymer or ceramic material.

14. The disk in claim 11 with additional waveguide slots in the end opening.

15. The disk in claim 11 made from a polymer, ceramic, or fiberglass type material with a sputtered or etched magnetic material on the surface.
